(19) United States
(12) Patent Application Publication
(10) Pub. No.: US 2012/0175003 A1
(43) Pub. Date: Jul. 12, 2012

(54) AIR-VENT SEALING PLUG AND CONDUIT SYSTEM

(76) Inventor: Abdel Shah, Mississauga (CA)

(21) Appl. No.: 13/190,051

(22) Filed: Jul. 25, 2011

(30) Foreign Application Priority Data
Jul. 27, 2010 (CA) 2711342

(51) Int. Cl. F16L 55/10

(52) U.S. Cl. 138/89

(57) ABSTRACT

An air-vent aperture sealing plug comprising a compressible resiliently flexible member of a size and shape as to be operably received and retained in tight air-sealing engagement in an air-vent unit within the aperture of a conduit. The plug allows for hot or cold air within a conduit system from a furnace or air conditioning unit, respectively, in a building to be cut off and re-directed as desired to provide enhanced personal comfort and reduced energy consumption.

### FIELD OF THE INVENTION

This invention relates to the sealing of hot or cold air-passing conduits in residences, offices and commercial buildings; particularly in order to desirably re-distribute the air.

### BACKGROUND OF THE INVENTION

There is a need to address the problem of hot or cold air passing from a furnace or air-conditioning unit, respectively, throughout a conduit system of a building going to rooms not requiring excessive amounts of hot or cold treated air. Some rooms, e.g. basements or lower level family rooms become too cold if air-conditioned air is allowed to exit the vents of the conduit system and while starving upper level rooms, particularly, bedrooms, in the Summer months. The reverse is true for hot air distribution in the Winter months.

There is, thus, a need to be able to regulate air-flow distribution through and from conduits to rooms to enhance the degree of personal comfort while reducing energy consumption.

### SUMMARY OF THE INVENTION

In one aspect, the invention provides, an air-vent aperture sealing plug comprising a compressible, resiliently flexible member of a size and shape as to be operably received and retained in tight air-sealing engagement in an air-vent unit within said aperture.

In one aspect, the invention provides a plug as hereinabove defined wherein said unit comprises a housing defining an air passage retained within an air conduit in air-sealed engagement; and a vent grill comprising a plurality of vanes longitudinally aligned across said housing and removable from said unit.

In one embodiment, the invention provides a plug as hereinabove defined wherein said flexible member is formed of a material selected from a sponge and thermally reflective bubble-pack insulation material.

In a preferred embodiment, the invention provides a plug as hereinabove defined wherein the bubble-pack insulation material comprises an aluminum foil polymer laminate or metallized polymer layer.

In preferred embodiments, the invention provides a plug as hereinabove defined comprising handle means.

In a further aspect, the invention provides an air-duct system comprising

(i) a conduit through which air is operably passed to a receiving chamber and comprising at least one portion defining an air outlet;

(ii) an air-vent unit within said air outlet;

(iii) said unit comprising a housing defining an air passage retained within an air conduit in air-sealed engagement; and a vent grill comprising a plurality of vanes longitudinally aligned across said housing and removable from said unit; and

(iv) a plug as hereinabove defined within said vent grill.

In further embodiments, the invention provides a system as hereinabove defined wherein the chamber is a room of a residence, office or commercial building; and said air has been heated or cooled.

The sealing plug is of use in outlet vents in the floor, walls and ceilings of rooms.

The plurality of vanes array may be closeable in its own right, according to the prior art.

In the present invention, the plurality of vanes is preferably integrally formed within a planar vent cover which is removable from the unit to allow access to the unit and insertion or removal of the plug as hereinabove defined.

The flexible material of the plug is preferably made of sponge, preferably treated with a flame resistant chemical.

However, most preferably, the plug material is selected from an aluminum polymer laminate and an aluminized polymeric film reflective insulation material bubble-pack assembly as described in Canadian Patent Nos. 2,554,754, issued 4 Dec. 2007 and 2,591,589, issued 29 Apr. 2008, to Furio Orologio. The aluminized polymeric film bubble-pack meets the Class 1, Class A, NFPA 286 Full Corner Burn Test—flame spread value.

The present invention discloses the use of such a reflective metal bubble-pack in a non-static thermal insulation system whereby it is intended that hot air, for example, continuously impacts the aluminum surface of the bubble-pack which acts as a barrier to the air flow rather than as an insulation medium.

### BRIEF DESCRIPTION OF THE DRAWINGS

In order that the invention may be better understood, preferred embodiments will now be described, by way of example only, with reference to the accompanying drawing wherein

FIG. 1 is a diagrammatic side sectional view of an air duct system according to the invention.

### DETAILED DESCRIPTION OF PREFERRED EMBODIMENTS

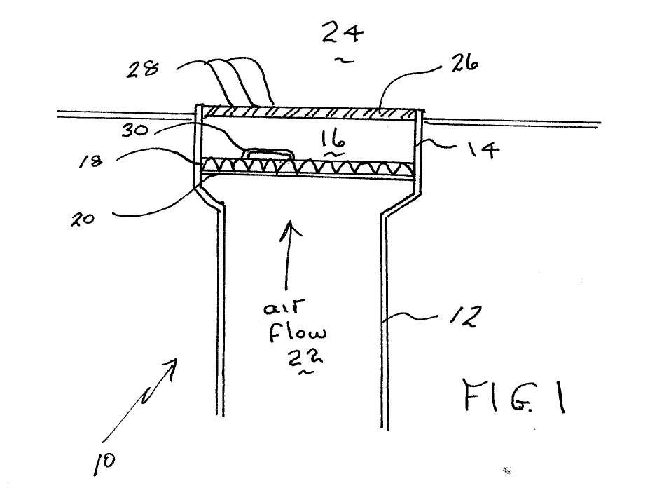

FIG. 1 shows a conduit system, in part, generally as 10 having a rectangular conduit 12 connected to a rectangular vent-grill unit 14 in air-tight engagement. Unit 14 defines an air passage 16 at the terminal portion of conduit 12 within which is retained in air-sealing engagement aluminized polyester single bubble-pack assembly 18 wherein aluminized polyester layer 20 inwardly faces hot air flow 22. Bubble-pack assembly 18 acts as an air-vent sealing plug into room 24.

Vent-grill unit 14 retains a removable end member 26 having a plurality of vanes 28 through which air is, selectively, allowed to pass in the absence of plug 18.

When operably desired, sealing plug 18 is of desired dimensions as to provide intimate contact in air-sealing engagement with vent grill 14 adjacent end-member 26 but, optionally, preferably at a distance within vent grill 14 as to be not visibly seen.

When desired, generally at a change in the seasons, sealing plug 18, is removed from air-vent unit 14. Handle 30 facilitates such removal.

In alternative embodiments, bubble-pack assembly 18 may comprise a double bubble or more array. Fire retardants and the like may be used in admixture with the polymer.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. An air-vent aperture sealing plug comprising a compressible, resiliently flexible member of a size and shape as to be operably received and retained in tight, air-sealing engagement in an air-vent unit within said aperture.

2. A plug as claimed in claim I wherein said unit comprises a housing defining an air passage retained within an air conduit in air-sealed engagement; and a vent grill comprising a plurality of vanes longitudinally aligned across said housing and removable from said unit.

3. A plug as claimed in claim 1 wherein said flexible member is formed of a material selected from a sponge and thermally reflective bubble-pack insulation material.

4. A plug as claimed in claim 3 wherein said bubble-pack insulation material comprises an aluminum foil polymer laminate or metallized polymer layer.

5. A plug as claimed in claim 1 comprising handle means.

6. An air-duct system comprising
(i) a conduit through which air is operably passed to a receiving chamber and comprising at least one portion defining an air outlet;
(ii) an air-vent unit within said air outlet;
(iii) said unit comprising a housing defining an air passage retained within an air conduit in air-sealed engagement; and a vent grill comprising a plurality of vanes longitudinally aligned across said housing and removable from said unit; and
(iv) a plug as defined in claim 1 within said vent grill.

7. A system as claimed in claim 6 wherein said chamber is a room of a residence, office or commercial building; and said air has been heated or cooled.
